(19) United States
(12) Patent Application Publication
(10) Pub. No.: US 2021/0385615 A1
(43) Pub. Date: Dec. 9, 2021

(54) SYSTEM AND METHOD FOR COMMUNICATING INFORMATION ABOUT TANGIBLE ARTICLES AVAILABLE FOR PHYSICAL DISPLAY TO A VIEWER

(71) Applicant: Anna A. Orzechowski, Winnipeg (CA)

(72) Inventor: Anna A. Orzechowski, Winnipeg (CA)

(21) Appl. No.: 17/234,991

(22) Filed: Apr. 20, 2021

(30) Foreign Application Priority Data
Jun. 3, 2020 (CA) 3081835

(51) Int. Cl. H04W 4/024; H04W 4/021; G06Q 50/10

(52) U.S. Cl. CPC H04W 4/024; G06Q 50/10; H04W 4/021

(57) ABSTRACT

There is disclosed a method for communicating information about a user's tangible articles of interest to a viewer for whom the articles of interest are available for physical display, and a system configured to execute the steps of the method. The method generally comprises a step of forming a database of electronic profiles of the articles of interest, forming in the database at least one grouping comprising a subset of the articles of interest based on user-selection of the electronic profiles of the subset of the articles, and providing to the viewer an application for download onto a mobile communication device to retrieve from the database the electronic profiles of the articles of interest belonging to the formed grouping.

This application claims the benefit of Canadian patent application ser. no. 3,081,835 filed Jun. 3, 2020.

### FIELD OF THE INVENTION

The present invention relates to a system and method for communicating information which is not integrally provided or displayed with physical or tangible articles of interest of a user which are to be physically displayed to a viewer.

### BACKGROUND

Organizations or institutions such as museums which make numerous items, articles or pieces of interest such as artifacts available for display to public viewers provide, in conjunction therewith, additional information about the artifacts enabling interpretation thereof when seen by the viewers. Additionally, these individual pieces are typically grouped in a manner determined by the presenting-institution, for example based on a common subject, to provide the viewer with a clearer understanding of a story or background subject represented by the individual pieces. Furthermore, the institution may suggest a recommended order in which the individual pieces are to be viewed to best understand the representative story.

Most traditionally, the information about each piece which is to be communicated to the viewer is provided in the form of a fixture mounted adjacent or in proximity to the piece, such as a substrate carrying indicia thereon or a screen displaying an image or a video or an audio speaker emitting sound.

Additionally or alternatively to the traditional approach, the museum provides to the viewer a portable personal communication device, which is to be carried by the viewer, with a screen or sound-emitting functionality to communicate the afore-described information in an individual manner to the viewer.

More recently, software applications which are downloadable onto personal mobile communication devices such as smartphones have been provided in lieu of a rented dedicated portable communication device, which reduces equipment to be managed by the museum.

Typically, the development of the content to be communicated to the viewer through the personal communication device is managed by a third-party organization, that is, not by the entity which manages the physical pieces with which the information is associated.

### SUMMARY OF THE INVENTION

According to an aspect of the invention there is provided a method for communicating information about a user's tangible articles of interest to a viewer for whom the articles of interest are available for physical display, the method comprising:

using a computing system, forming, for each article of interest, a distinct profile based on input from the user so as to form a database;

wherein the profile for each article of interest comprises:
a label for the article of interest;
a description in the form of text for the article of interest; and
an image file representative of the article of interest;

using the computing system, forming a grouping of a subset of the articles of interest based on user-selection of the profiles of the subset of the articles of interest;

using the computing system, providing, to the viewer, an application for download onto a mobile communication device to retrieve from the database the electronic profiles of the articles of interest belonging to the formed grouping.

This provides an arrangement usable by the user to manage and develop content about their articles of interest that is to be communicated to the viewer.

Optionally, forming the distinct profile for each article of interest further comprises, using the computing system:

converting the textual description to an audio file comprising a narration of the textual description and storing the audio file in association with the profile of the article of interest.

Preferably, converting the textual description to the audio file comprises, using the computing system, generating the audio file based on a user-selection of at least one of a narrator voice gender and a narrator voice accent.

Optionally, the method further includes, using the computing system, providing the audio file for download by the user for use outside the database or the application.

Optionally, forming the distinct profile for each article of interest further comprises, using the computing system, generating a distinct barcode to be associated with the profile, by which the profile can be retrieved by the viewer through the application.

Preferably, forming the grouping of the subset of the articles of interest comprises, using the computing system, forming a profile for the grouping based on input from the user, wherein the profile for the grouping comprises:

a label of the grouping; and

a description of the grouping.

Optionally, the profile further includes:

a start date and an end date defining a period of time during which the grouping is available to the viewer through the application.

Optionally, forming the grouping of the subset of the articles of interest further includes, using the computing system, arranging the profiles of the subset of the articles of interest in a user-defined order, so that the viewer retrieving the grouping through the application is guided to view the articles of interest belonging thereto according to the user-defined order.

Preferably, the profile for each article of interest includes a user-defined category for classifying a type of the article of interest, so that the profiles of articles of interest of a common type are sorted by the system into a separate collection independent of the grouping to which said articles of interest belong.

Preferably, the profile for each article of interest includes a user-defined numerical identifier, so that the profile can be retrieved through the application by inputting said numerical identifier.

Preferably, forming the distinct profile for each article of interest includes, using the computing system, converting the image file to a searchable image associated with the profile for matching with a viewer-provided image input to the application to retrieve said profile.

Optionally, forming the distinct profile for each article of interest includes, using the computing system, identifying on a map a location of the article of interest.

Optionally, forming the distinct profile for each article of interest includes, using the computing system, associating a sponsor with the article of interest for display to the viewer upon retrieval of the profile.

Preferably, the application to be downloaded by the viewer comprises a representative icon for display on the mobile communication device, which is provided by the user.

Preferably, the method further includes, using the computing system, requesting, from the user, login information through a unique web address provided to the user in order to access the database through the provided web address.

Optionally, the method further includes, using the computing system, forming a calendar of events in which time period availability of the grouping is stored and dates of other events for the viewer that are associated with the user.

Preferably, the method further includes, using the computing system:

storing information about a sponsor; and

displaying, to the viewer, through the application, a pop-up advertisement about the sponsor.

Preferably, the method further includes, using the computing system:

storing banking information of the user for receiving money from the viewer; and

providing, to the viewer, through the application, a money tool for transferring money to the user via the user-provided baking information.

Preferably, the method further includes, using the computing system:

storing information about time periods of availability of the articles of interest for display to the viewer; and

providing, through the application, said time periods of availability for display to the viewer.

In one arrangement, the method further includes, using the computing system:

receiving as input from the application a query in respect of an article of interest;

checking the database to locate a profile corresponding to the article of interest of the query, and

if said profile is located, providing, through the application, said profile for display to the viewer through the application; or

if the database does not contain said profile:
retrieving from a publicly available data source information about the article of interest of the query;
forming a profile for the article of interest of the query in the database based on the retrieved data; and
providing, through the application, the profile of the article of interest of the query for display to the viewer.

In one such arrangement, the query is in the form of text generated from a viewer-provided image input to the application.

In one arrangement, the method further includes, using the computing system, providing, through the application, the electronic profiles of the articles of interest belonging to the formed grouping for download onto the mobile communication device for subsequent retrieval.

According to another aspect of the invention there is provided a system for communicating information about a user's tangible articles of interest to a viewer for whom the articles of interest are available for physical display, the system being configured to execute the following steps:

forming, for each article of interest, a distinct profile based on input from the user so as to form a database;

wherein the profile for each article of interest comprises:
a label for the article of interest;
a description in the form of text for the article of interest; and
an image file representative of the article of interest;

forming a grouping of a subset of the articles of interest based on user-selection of the profiles of the subset of the articles of interest;

providing, to the viewer, an application for download onto a mobile communication device to retrieve from the database the electronic profiles of the articles of interest belonging to the formed grouping.

### BRIEF DESCRIPTION OF THE DRAWINGS

The invention will now be described in conjunction with the accompanying drawings in which:

FIG. 1 is a schematic diagram of various actors which are relevant to a communication system according to the present invention;

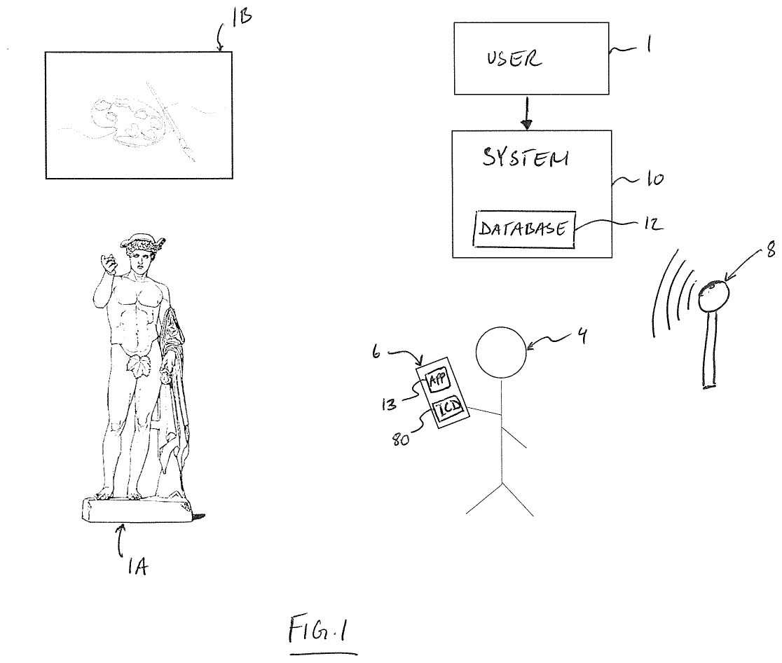

FIG. 2 is a schematic diagram of an electronic profile of an article of a user which is formed using the system of FIG. 1;

FIG. 3 is a schematic diagram of the system of FIG. 1;

FIG. 4 is a schematic diagram of an application of FIG. 1; and

FIG. 5 is a schematic diagram showing further detail of the system of FIG. 1.

In the drawings like characters of reference indicate corresponding parts in the different figures.

### DETAILED DESCRIPTION

The accompanying figures show a system 10 for communicating information about tangible or physical articles of interest of a user, for example statues 1A or paintings 1B, to a viewer 4 for whom the articles are available for physical display. Generally speaking, the user 1 who owns or is at least responsible for managing viewing of the articles such as 1A, 1B interacts with the system 10 to input into the system information which is not integrally provided or displayed with the articles of interest 1A, 1B so that this information can subsequently be accessed by the viewer 4 via their personal mobile communication device 6. Information or data is transmitted from the system 10 to the personal device 6 via a wireless communication network 8 such as a wireless local access network or a cellular data network.

The system 10 generally comprises a user-created electronic database 12 storing the information to be communicated about the tangible articles of interest and a software application 13 for download onto the mobile communication device 6 which facilitates viewer access to the database 12 in order to retrieve therefrom the information on the articles of interest.

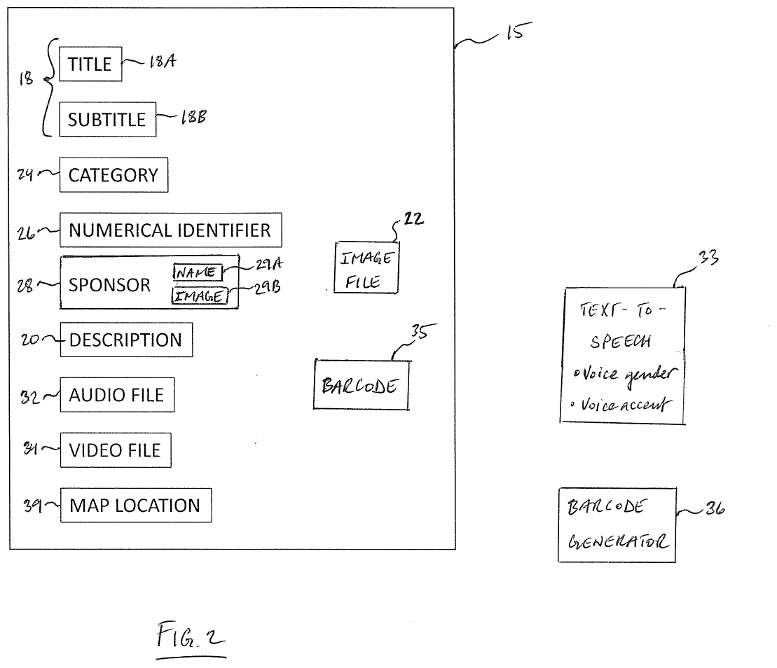

Referring now to FIG. 2, a first step in forming the database 12 on the system 10, which the system is configured to execute, is to form, for each article of interest such as 1A, 1B, a distinct profile 15 based on input from the user 1. That is, each article has its own individual profile containing identifying and descriptive information.

The profile 15 for each article of interest comprises, at least:

a label 18, in the form of text, for the article of interest, such as a name or title 18A and an optional subtitle 18B which is used for identifying the article of interest to distinguish the same from other articles, which is generally unique to the article of interest;

a description 20, in the form of text, for the article of interest, which provides further information about the article of interest which is not integral with the article so as not to form a part of same (that is, this is generally additional to whatever is already visible on the article); and

an image file 22 representative of the article of interest, for example a photograph or reproduction of an actual appearance of the article.

In the illustrated arrangement, the profile 15 also includes a user-defined category 24 for classifying a type of the article of interest. This is generally a generic textual label assigned by the user to the article, which is reused for other articles of the same type so as to form one class of related articles to be simultaneously retrieved from the system 10. The system 10 automatically forms for user management a separate independent collection 25 in the database 12 of all article profiles belonging to a common category 24 enabling the user to quickly sort through the profiles of articles of a particular type. In other words, the article category acts as one filter by which to shortlist the profiles of all available articles of interest to those desired by the user.

The profile 15 further includes a user-defined numerical identifier 26, which is a unique numerical label assigned by the user to the article of interest, that is searchable as will be better appreciated shortly, so that the profile can be retrieved through the viewer application 13 by inputting the numerical identifier 26.

Yet further, the profile 15 includes sponsor information 28 which enables a third-party, which is neither the user nor the system provider, to be advertised in association with communication of the information about the particular article of interest. This third-party may be for example a business, an individual or a family. As such there is provided to the user a text field 29A to input a name of the sponsor and a memory location 29B in the profile 15 to upload to the system a representative image for the sponsor.

As part of the step of forming the profiles 15 for the articles of interest, the system 10 is configured to convert the textual description 20 to an audio file 32 comprising a narration of the textual description, and is further configured to store the audio file in association with the profile of the article of interest so that when the profile is retrieved, the audio file is retrieved also or is made accessible therethrough.

As part of the step of converting the textual description 20 to the audio file, the system is configured to generate the audio file 32 based on a user-selection of at least one of a narrator voice gender and a narrator voice accent provided through a text-to-speech conversion tool 33 of the system 10. For example, several selectable options for narrator voice gender can be provided such as female, male and neutral. Moreover, selectable options for narrator voice accent may include British, American or Australian.

Generally speaking, both the textual description 20 and the audio version of same, which is indicated at 32, are made available to the viewer through the article profile.

The system is configured to provide the audio file 32 for download by the user 1 for use outside the database 12 or application 13, or more generally the system 10.

The profile 15 additionally includes an optional video file 34 which can be uploaded to the system 10 for association with the profile and which generally provides supplementary information about the article to that information already provided by the description 20 or audio file 32, which are substantially the same in content but present the same in a different manner to the viewer 4 who views the actual article 1A, 1 B.

The system 10 is also configured to generate, as part of forming the individual profile 15, a distinct barcode 35 such as a Quick Response code to be associated with the profile 15, by which the profile can be retrieved by the viewer through the application 13. This is an alternative to the numerical identifier 26 which is assigned by the user. The barcode is provided by a barcode generation tool 36 of the system 10.

As a further alternative for retrieving the profile of a viewer-specified one of the articles of interest, the system 10 is configured to convert the image file 22 to a searchable image associated with the profile 15 for matching with a viewer-provided image which is taken of the actual article during viewing. This may be performed automatically by the system 10 upon input of the image file 22 by the user into the profile 15. As such, more generally speaking, the image 22 may be made available by the system for searching as an input query of the viewer.

To help the viewer locate the article of interest, the system 10 is configured to identify or tag, in the profile 15 at 39, a location of the article of interest on a user-provided map. The system 10 is configured to accept the map 40 as input from the user for storage and retrieval in a separate memory location from the profile 15, where additional maps can be added or previously stored maps removed.

After being created, each article profile 15 is stored on the system 10 in the database 12 for subsequent use and retrieval.

Each article profile 15 is available for independent editing of other articles with stored profiles which were previously created by the user.

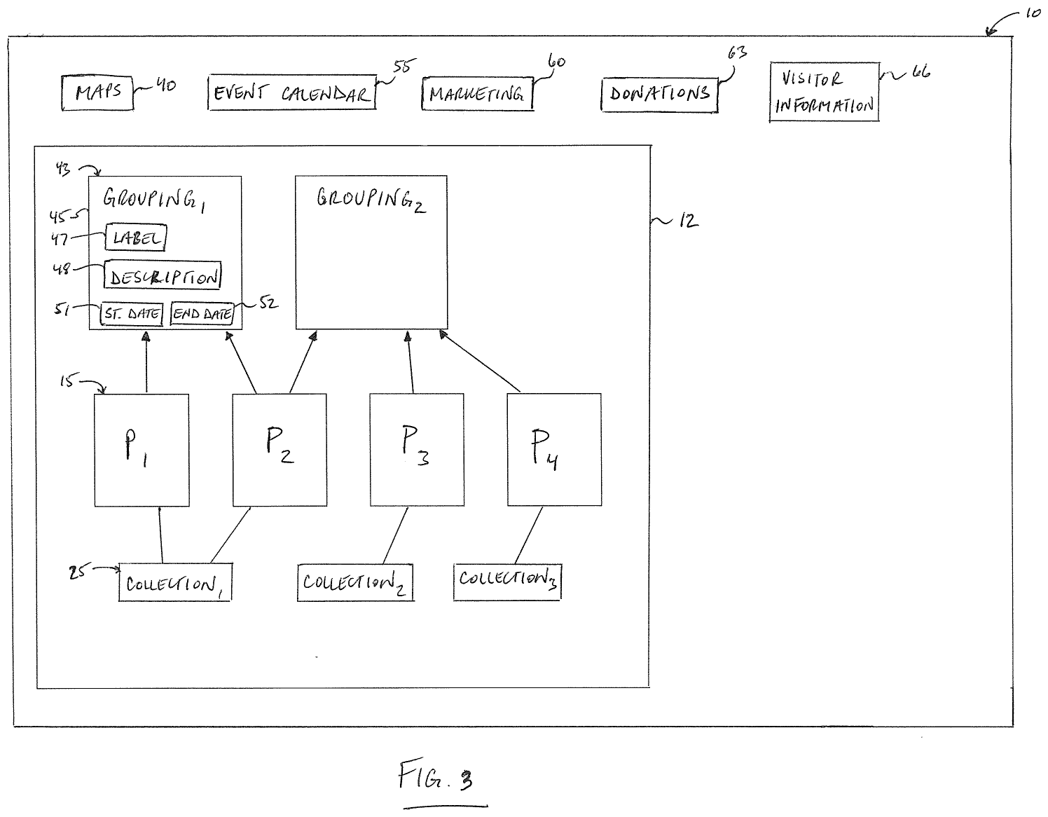

Turning now to FIG. 3, once the profiles 15 of the articles of interest have been created and stored, the system 10 is configured to form at least one grouping 43 comprising a subset of the articles of interest based on user-selection of the profiles 15 of the subset of the articles of interest. The user 1 generally has a diverse collection of articles such that all of the articles belong to various groupings 43 each of which is based on a common characteristic, attribute or background history of its constituent articles.

In the illustrated example embodiment, two groupings GROUPING₁ and GROUPING₂ are formed and subsequently stored in the database 12. Previously created article profiles P₁ through P₄ are available to be assigned by the user 1 to one or multiple groupings. As such, article profiles P₁ and P₂ which contain information about distinct articles, such as those indicated at 1A and 1B, are assigned to GROUPING₁, and article profiles P₂ through P₄ are assigned to GROUPING₂, as indicated by the linking arrows in FIG. 3. It will also be appreciated that profiles P₁ and P₂ have the same category and are sorted for filtering in the system 10 under COLLECTION₁, and profiles P₃ and P₄ each belong to different categories from the other profiles and accordingly have been sorted by the system into COLLECTION₃ and COLLECTION₄, respectively.

Initially, the grouping 43 is formed by creating a profile 45 therefor. The grouping profile 45 is substantially similar to the article profile 15, so as to have similar components like those previously described herein, but at least includes a label 47 of the grouping which is in the form of a textual identifier for distinguishing the respective grouping from other groupings, and a description 48 of the grouping which is in the form of text which provides further information as to contents of the grouping. It will be appreciated that only one of the groupings illustrated in FIG. 3, that is GROUPING₁, has constituent parts thereof shown for clarity and convenience of illustration.

In contrast to the article profile 15, which is created to exist for an indefinite period of time, basically for as long as the article remains available for presentation by the user 1, the grouping profile 45 typically includes a start date 51 and an end date 52 defining a limited period of time during which the grouping 43 is available to the viewer through the application. The date information may additionally include time information, to define open and closing times for the start and end dates, respectively.

The start and end dates 51, 52 of each grouping 43 may be linked with a calendar of events 55 formed on the system 10 to store in a generally common location on the system time period availability of all of the formed groupings as well as dates of other events which are associated with the user for participation by the viewer. The event calendar 55 may be configured to retrieve from the system 10 the start and end date information of the groupings 43 and to permit editing of same.

In the step of forming the grouping 43, the system 10 is also configured to arrange the profiles 15 of the user-selected subset of the articles of interest in a user-defined order, so that the viewer retrieving the grouping through the application is guided to view the articles of interest belonging thereto according to the user-defined order.

Thus, generally speaking there are two types of groupings 43: (i) a non-ordered set of the articles, which is suited for exploring the grouped articles of interest in any order desired by the viewer, which can be termed an ‘exhibit’ which is particularly suited in certain contexts of users for example a museum; and (ii) an ordered series of the articles, which can be termed a ‘tour’ which is particularly suited in certain contexts of users for example a museum. Typically, tours are provided with an estimated completion time to inform the viewer of an anticipated duration of time for viewing all of the articles of the ordered grouping if conducted in the prescribed order.

That is, the groupings 43 of the articles generally define which profiles 15 of the user's articles are accessible through the application 13, as not all of the articles with profiles stored in the database 12 may be on display at a given time. In other words, the groupings 43 restrict viewer-retrieval from the database 12 to the articles profiles 15 that are included in the formed groupings 43 which are designed by the user as available for access at a prescribed time.

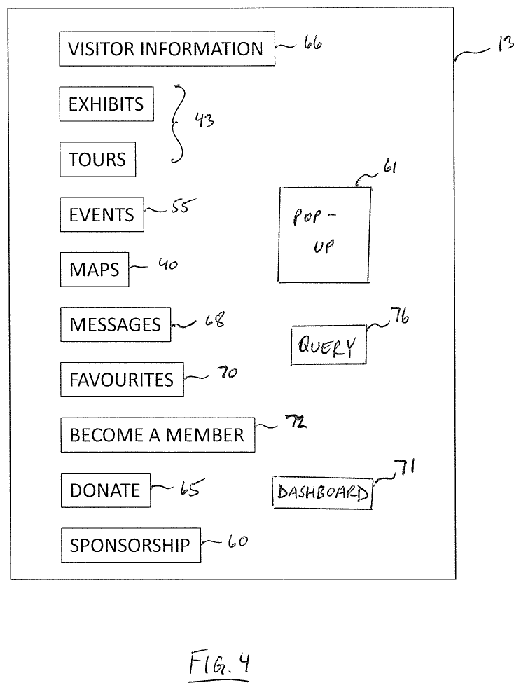

Turning now to FIG. 4 with some reference to FIG. 3, after at least one grouping 43 is formed, the system 10 is configured to provide, to the viewer, the application 13 for download onto the personal mobile communication device 6 to retrieve from the database 12 the electronic profiles 15 of the articles of interest belonging to the formed groupings.

The application 13 has a predefined configuration or framework, which is set by the system 10. The application 13 is populated by the information that is input to the system 10 by the user 1. This includes the grouping profiles 45 and the article profiles 15, and other information which will be described later.

The application 13 displays to the viewer 4 the various groupings 43 which are available at the time of accessing the application, based on time period of availability of the groupings 43.

A selected one of the groupings 43 is accessed by viewer-selection through the application 13, which consequently makes available to the viewer 4 select ones of the articles profiles 15 that have been assigned to the selected grouping 43.

The system 10 is configured to receive as input thereto a representative icon for the application 13 comprising indicia or a graphic that is to be displayed on the mobile communication device, which is provided as input to the system 10 by the user 1. This is another customizable feature which is provided by the system 10.

In addition to the article profiles 15, the groupings 43, the maps 40 and the event calendar 55, the system 10 is additionally configured to store, in a marketing section of the system 10 that is indicated at 60, information about a sponsor which is input by the user 1 and to display, to the viewer 4, through the application 13, a pop-up advertisement 61 about the sponsor which is prepared by the system 10 using the information input by the user 1. A frequency and timing of the pop-up ads can be controlled in the marketing section 60. The pop-up ads may be coordinated with the article profiles 15 which contain sponsor information such the system 10 selects for display to the viewer 4 through the application 13 advertising information for the sponsor at 28 of a recently viewed profile 15. This may also be performed in association with the groupings which may have different sponsors than their constituent article profiles.

Furthermore, the system 10 is configured at 63 to store banking information of the user 1 for receiving money such as in the form of donations from the viewer 4, which information is received by the system 10 as input by the user 1, and subsequently to provide, to the viewer 4, through the application 13, a tool 65 for transferring money to the user via the user-provided baking information. This may be specifically a donation tool as shown in FIG. 4. It will be appreciated however that the banking information may also be used for depositing funds received in association with sales conducted through the application 13 for example membership fees or individual tickets.

Moreover, the system 10 is configured at 55 to store information about time periods of availability of the articles of interest for display to the viewer 4, and to provide, through the application 13, the time periods of availability for display to the viewer 4. This is independent of the groupings 43 which are accessible through the application based on the time of access by the viewer.

Also, the system 10 is configured at 66 to store business hour information of the user 1, and to provide, through the application 13, this information for selective display to the viewer 4 when desired thereby.

The system 10 may additionally be configured to:

Post messages from the user to the viewer for display in the application 13, as at 68;

Enable viewer-selection or designation of favourite articles of interest, as at 70, to generate a list of profiles of articles designated as favourites for retrieval by the viewer 4 at a later time—these items may be stored in a viewer-customizable dashboard 71 which provides additional information specific to the viewer, based on input from the viewer through the application or based on data about the viewer which is gathered by the system 10 via the application 13 running on the mobile communication device 6;

Enable subscription of the viewer to the user's services or products, as at 72.

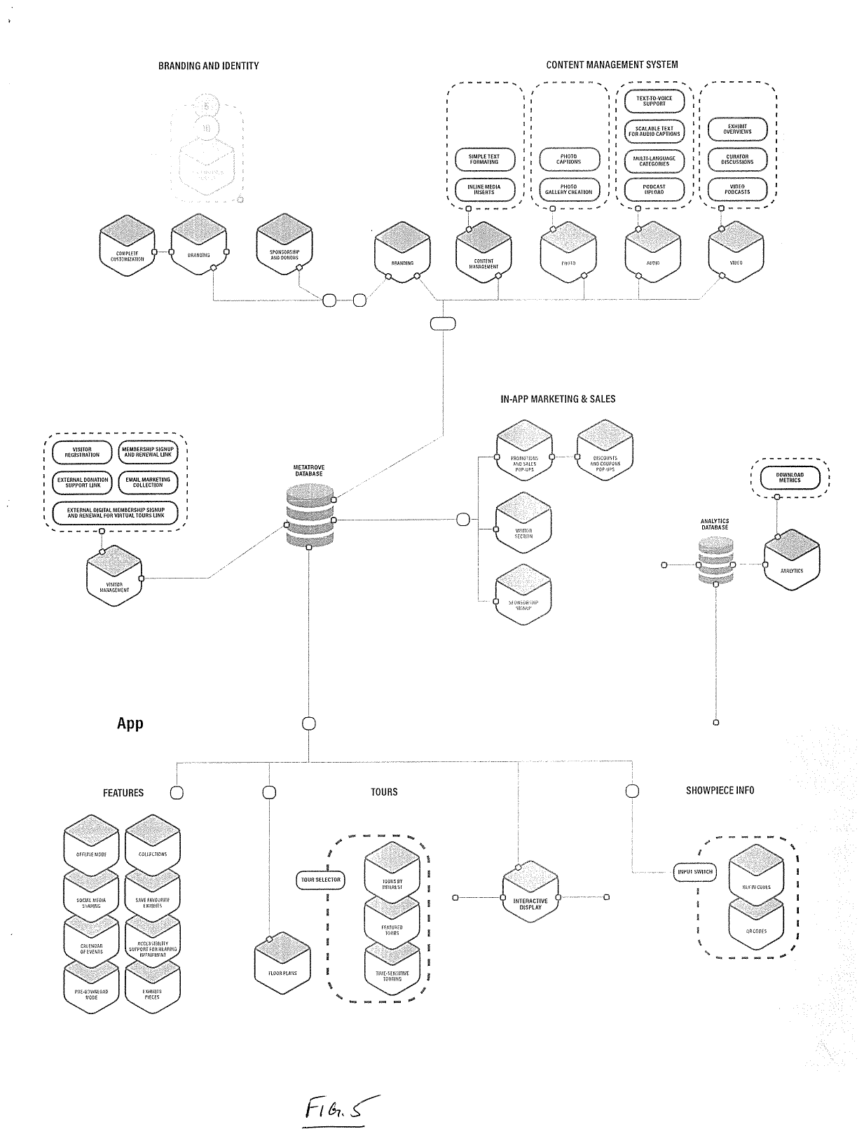

FIG. 5 is a schematic diagram of an architecture of the system 10, portions of which have already been described hereinbefore.

In use, the system 10 provides each user 1 with access thereto, for forming and subsequently storing a database 12 of article profiles and higher-level groupings 43 into which the select profiles 15 are organized by the user, through a unique web address provided to the user 1. Thus, as a preliminary step, the system 10 requests, from the user 1, login information through the provided web address for subsequent access to the database 12, entries in which are to be formed, edited or otherwise managed by the user 1.

After logging in, the user 1 interacts with the system 10 through a dashboard graphical interface which enables the user 1, at the least, to form electronic profiles 15 for articles of interest in the user's inventory containing non-integral descriptive content of the articles; and to form user-defined groupings of select articles to grant access to the viewer, through selection of the grouping on the application 13, to the profiles of those select articles. The groupings 43 are formed by creating a distinct electronic profile 45 for each grouping and subsequently linking select article profiles 15 therewith.

To create a profile 15 for each article of interest, upon navigation to the relevant page of the user interface of the system 10, the system acts to request, from the user 1, input as to the various fields available on the profile 15. These are presented to the user 1 as text-input fields or file-attachment fields.

To create a profile 45 for a grouping, the process is similar to that described in the previous paragraph in relation to article profiles 15, except that this is a distinct page of the system's user interface.

To add article profiles 15 to a grouping, the system 10 displays to the user a list of all previously created article profiles which the user can readily distinguish by the labels 18 thereof (typically just the titles 18A are displayed). From this list the user 1 can then select or unselect profiles to be included in the grouping. Thus each grouping 43 is customizable by the user. Each grouping can also be edited independently of other groups, similar to the article profiles 15.

When a specific order of articles is desired in a grouping, the system 10 displays to the user 1 a list of selected profiles only in which each list item can be rearranged in order to form a user-defined ordering.

Thus the database 12 is formed in the system 10 by the user 1.

The system 10 populates the information from the user 1, which has been stored in the database 12 or generally in the system 10, in the application 13.

The user-input information is accessible by the viewer 4 through the application 13 after download to the viewer's personal mobile communication device 6.

The information about the user's articles is available to the viewer 4 in distinct pages of the application 13 through the user-defined groupings 43. The application 13 differentiates between groupings comprising non-ordered sets of articles, which are termed “exhibits”, and grouping comprising ordered series of articles, which are termed “tours”. The viewer selects a desired grouping 43 and by this action is able to access the profiles of the subset of articles forming the selected grouping.

When the viewer selects a tour, each profile 15 is retrieved in the user-defined order so that the viewer 4 is guided to view the articles of interest according to the user-defined order.

Particularly when exploring an exhibit, as the application 13, or more generally the system 10 and the user 1, cannot anticipate the order in which the articles therein will be viewed, the viewer 4 is able to retrieve a specific one of the article profiles 15 in the non-ordered grouping by inputting into the application 13 at 76 one of an image of the actual article captured by the viewer, the numerical identifier or the barcode which are displayed to the viewer on a fixture mounted in proximity to the actual article.

This provides an arrangement usable by the user 1 to manage and develop content about their articles of interest that is to be communicated to the viewer 4. The system 10 defines an application 13 for the viewer which can be populated with the content prepared by the user. It will be appreciated that the information made available to the viewer through the application 13 on their mobile communication device 6 may also be made available on a website which is hosted by the user or otherwise managed thereby and provided for access on an internet browser application.

As described hereinbefore the present invention relates to a method for communicating information about a user's tangible articles of interest to a viewer for whom the articles of interest are available for physical display, and a system configured to execute the steps of the method. The method generally comprises a step of forming a database of electronic profiles of the articles of interest, forming in the database at least one grouping comprising a subset of the articles of interest based on user-selection of the electronic profiles of the subset of the articles, and providing to the viewer an application for download onto a mobile communication device to retrieve from the database the electronic profiles of the articles of interest belonging to the formed grouping.

The user may be for example:

a tourism agency of a municipality or city which has landmarks or other tourist attractions available for visiting by tourists acting as the viewers in respect thereof;

a zoo or aquarium; or

a museum.

The system described hereinbefore may also be referred to as a content management system which enables the user to manage content associated with tangible articles that are in the possession or otherwise managed by the user.

In some arrangements, the application 13 provides an option to access a virtual tour of the tangible article of interest for example during time periods when they are not accessible for physical viewing.

In some cases the user who is typically a human user may input the information into the system 10 manually, in order to form the database 12, and in other cases the user may use a software program, which may be termed in industry as a bot, which is configured to collect the information and automatically input the same into the system 10. Thus information is input to the system either directly or indirectly from the user.

In addition or alternatively to the existing profiles 15 formed by the user and already accessible to the viewer through the application 13 in the manners previously described, the viewer 4 may provide to the computing system 10 through the application 13 a search query 76 in respect of an article of interest which may not be catalogued in the database 12 and which for example is in the vicinity of the user. In this case the computing system 10 receives as input from the application 13 on the mobile communication device 6 the query in respect of an article of interest provided by the viewer. For example, the query is generated by the application 13 by real-time scanning of the article of interest using the mobile communication device 6 with image capture functionality (that is, the mobile communication device has an image capture device (ICD) 80). As such the application 13 is configured to capture an image of the article of interest. The application 13 is configured to subsequently generate the query, for transmission to the computing system 10, in the form of text from the viewer-provided image input to the application 13 by applying a machine learning algorithm to process the image to determine the article of interest contained therein. Alternatively, the query is in the form of the image captured by the mobile communication device 6 and input to the application 13.

After receiving the query from the application 13 over the communication network 8, the computing system 10 performs a step of checking the database 12 to locate a profile corresponding to the article of interest of the query. This may be performed by searching the profile labels 18 for matching with the text query, or by searching the image files 22 for matching with the image query by applying an image processing algorithm to select the profile having the image file which corresponds above a threshold likelihood (usually in the form of a percentage similarity) determined by the algorithm.

If the profile is located, that is the database 12 already contains an existing profile 15 corresponding to the article of interest identified by the query, then the computing system 10 is configured to provide, through the application 13, the profile for display to the viewer 4 through the application. The application 13 may be configured to superimpose contents of the existing stored profile on the image during real-time scanning of the actual article.

In this manner input of the query may act to make available for retrieval through the application profiles of articles of interest not selected by the user to belong to the grouping(s) already accessible through the application 13.

Alternatively, if the database 12 does not contain a profile corresponding to the article of interest identified by the query, then the computing system 10 is configured to automatically retrieve from a publicly available data source, such as a trusted website on the Internet, information about the article of interest of the query; to form a distinct profile 15 for the article of interest of the query in the database 12 based on the retrieved data; and to provide, through the application 13, the formed profile 15 of the article of interest of the query for display to the viewer. Thus in this manner a new profile is formed in the database based on input from the viewer.

In some arrangements, the computing system 10 is configured to provide, through the application, the electronic profiles 15 of the articles of interest belonging to the formed groupings for download onto the mobile communication device for subsequent retrieval. This may be termed as an offline mode for convenient reference.

The system 10 may be further configured to:

Enable, via the application 13, posting of contents of a profile 15, which is stored on the database 12, to a third-party social media platform for access by others through the Internet;

Enable, via the application 13, sorting of the groupings 43 available on the application based on viewer-interest, suggestions based on data about the viewer 4 which is gathered by the system 10 via the application 13 running on the mobile communication device 6, or duration of time in the case of ordered groupings—in other words, all of the groupings 43 which are accessible via the application 13 may be filtered based on one of the foregoing parameters.

The scope of the claims should not be limited by the preferred embodiments set forth in the examples but should be given the broadest interpretation consistent with the specification as a whole.

1. A method for communicating information about a user's tangible articles of interest to a viewer for whom the articles of interest are available for physical display, the method comprising:
using a computing system, forming, for each article of interest, a distinct profile based on input from the user so as to form a database;
wherein the profile for each article of interest comprises:
a label for the article of interest;
a description in the form of text for the article of interest; and
an image file representative of the article of interest;
using the computing system, forming a grouping of a subset of the articles of interest based on user-selection of the profiles of the subset of the articles of interest;
using the computing system, providing, to the viewer, an application for download onto a mobile communication device to retrieve from the database the electronic profiles of the articles of interest belonging to the formed grouping.

2. The method of claim 1 wherein forming the distinct profile for each article of interest further comprises, using the computing system:
converting the textual description to an audio file comprising a narration of the textual description and storing the audio file in association with the profile of the article of interest.

3. The method of claim 2 wherein converting the textual description to the audio file comprises, using the computing system, generating the audio file based on a user-selection of at least one of a narrator voice gender and a narrator voice accent.

4. The method of claim 2 further including, using the computing system, providing the audio file for download by the user for use outside the database or the application.

5. The method of claim 1 wherein forming the distinct profile for each article of interest further comprises, using the computing system, generating a distinct barcode to be associated with the profile, by which the profile can be retrieved by the viewer through the application.

6. The method of claim 1 wherein forming the grouping of the subset of the articles of interest comprises, using the computing system, forming a profile for the grouping based on input from the user, wherein the profile for the grouping comprises:
a label of the grouping; and
a description of the grouping.

7. The method of claim 6 wherein the profile further includes:
a start date and an end date defining a period of time during which the grouping is available to the viewer through the application.

8. The method of claim 1 wherein forming the grouping of the subset of the articles of interest further includes, using the computing system, arranging the profiles of the subset of the articles of interest in a user-defined order, so that the viewer retrieving the grouping through the application is guided to view the articles of interest belonging thereto according to the user-defined order.

9. The method of claim 1 wherein the profile for each article of interest includes a user-defined category for classifying a type of the article of interest, so that the profiles of articles of interest of a common type are sorted by the computing system into a separate collection independent of the grouping to which said articles of interest belong.

10. The method of claim 1 wherein the profile for each article of interest includes a user-defined numerical identifier, so that the profile can be retrieved through the application by inputting said numerical identifier.

11. The method of claim 1 wherein forming the distinct profile for each article of interest includes, using the computing system, converting the image file to a searchable image associated with the profile for matching with a viewer-provided image input to the application to retrieve said profile.

12. The method of claim 1 wherein forming the distinct profile for each article of interest includes, using the computing system, identifying on a map a location of the article of interest.

13. The method of claim 1 wherein forming the distinct profile for each article of interest includes, using the computing system, associating a sponsor with the article of interest for display to the viewer upon retrieval of the profile.

14. The method of claim 1 wherein the application to be downloaded by the viewer comprises a representative icon for display on the mobile communication device, which is provided by the user.

15. The method of claim 1 further including, using the computing system, requesting, from the user, login information through a unique web address provided to the user in order to access the database through the provided web address.

16. The method of claim 1 further including, using the computing system, forming a calendar of events in which time period availability of the grouping is stored and dates of other events for the viewer that are associated with the user.

17. The method of claim 1 further including, using the computing system:
storing information about a sponsor; and
displaying, to the viewer, through the application, a pop-up advertisement about the sponsor.

18. The method of claim 1 further including, using the computing system:
storing banking information of the user for receiving money from the viewer; and
providing, to the viewer, through the application, a tool for transferring money to the user via the user-provided baking information.

19. The method of claim 1 further including, using the computing system:
storing information about time periods of availability of the articles of interest for display to the viewer; and
providing, through the application, said time periods of availability for display to the viewer.

20. The method of claim 1 further including, using the computing system:
receiving as input from the application a query in respect of an article of interest;
checking the database to locate a profile corresponding to the article of interest of the query, and
if said profile is located, providing, through the application, said profile for display to the viewer through the application; or
if the database does not contain said profile:
retrieving from a publicly available data source information about the article of interest of the query;
forming a profile for the article of interest of the query in the database based on the retrieved data; and
providing, through the application, the profile of the article of interest of the query for display to the viewer.

21. The method of claim 20 wherein the query is in the form of text generated from a viewer-provided image input to the application.

22. The method of claim 1 further including, using the computing system, providing, through the application, the electronic profiles of the articles of interest belonging to the formed grouping for download onto the mobile communication device for subsequent retrieval.

23. A system for communicating information about a user's tangible articles of interest to a viewer for whom the articles of interest are available for physical display, the system being configured to execute the following steps:
forming, for each article of interest, a distinct profile based on input from the user so as to form a database;
wherein the profile for each article of interest comprises:
a label for the article of interest;
a description in the form of text for the article of interest; and
an image file representative of the article of interest;
forming a grouping of a subset of the articles of interest based on user-selection of the profiles of the subset of the articles of interest;
providing, to the viewer, an application for download onto a mobile communication device to retrieve from the database the electronic profiles of the articles of interest belonging to the formed grouping.
